(19) United States
(12) Patent Application Publication
(10) Pub. No.: US 2017/0191588 A1
(43) Pub. Date: Jul. 6, 2017

(54) Integrated Safety Clamp

(71) Applicant: Thomas F Edwards, Rockport, TX (US)

(72) Inventor: Thomas F Edwards, Rockport, TX (US)

(21) Appl. No.: 15/386,357

(22) Filed: Dec. 21, 2016

Related U.S. Application Data
(60) Provisional application No. 62/272,855, filed on Dec. 30, 2015.

(51) Int. Cl. F16L 21/06

(52) U.S. Cl. CPC F16L 21/065

(57) ABSTRACT

An Integrated Safety Clamp is disclosed for use with hoses in high pressure applications such as oil and gas, and in particular a type of rotary and vibrator hose, called Choke and Kill hoses. The inventive clamp includes first and second main bodies that are connected to each other through a set of flanges. A set of gussets strengthen attachments between the first and second pairs (or sets) of flanges. Each flange includes at least two bolt openings. The safety clamp includes an opening to secure a chain or wire rope sling thereto. The safety clamp with at least four bolts provides a more robust and secure connection for hoses carrying high pressure liquids than current safety clamps. Due to its design, the safety clamp holds a hose firmly without damaging its inner workings or armor.

### CROSS REFERENCE TO RELATED APPLICATION(S)

This is a non-provisional patent application based on co-pending U.S. Provisional Patent Application Ser. No. 62/272,855 (Attorney Docket No. TE-15-1) previously titled “Integrated Safety Clamp”, filed on Dec. 30, 2015, the priority of which is hereby claimed and the disclosure of which is incorporated herein by reference in its entirety.

### BACKGROUND

Field of the Invention

The present invention relates to a safety clamp. More particularly, the present invention relates to an Integrated Safety Clamp for holding rotary or vibratory hoses and more particularly for securing a Choke and Kill hose that carries fluids under high pressure conditions.

Description of the Related Art

Industries such as oil and gas need hoses to carry fluids under high pressure, usually about or greater than 5,000 psi of pressure (and up to about 15,000 psi or more), from one location to another. Typically vibrator or rotary hoses are employed for these applications and the hoses are secured to the side of an oil derrick. The hoses undergo extreme conditions of pressure, temperature, time under pressure, and possibly corrosive, caustic, acidic or damaging (to the environment or parts surrounding the hose) fluids, which might lead to leakage or bursting. The bursting of the hoses under high pressure conditions might harm workers or damage nearby equipment. To improve the safety of the working conditions, traditionally safety clamps are being used with the hoses. The safety clamps firmly hold the hoses and restrain them from whipping in the event of hose failure, and possibly, blowing out or harming workers. For example, the clamps have a chain or rope secured thereon so in the event of hose failure while under high pressure, the hose is restrained and will not whip.

A conventional safety clamp has two halves and corresponding pairs of connection flanges attached thereto. Each conventional safety clamp half is attached to the adjoining half by a connection bolt through each flange. Traditionally, the bolts are about 0.5 inch (½) to about 0.75 inch (¾″). The bolts are tightened to couple the halves on the hoses. Over a period of time, from vibration of the hose or possible well fire, the bolts of the safety clamps may loosen. In such a case, the flanges and consequently the halves decouple which results in failure of the safety clamp. The conventional safety clamps with single bolt openings (on each half of the flange) do not hold the hoses securely at all times, nor do they allow for the use on armor-covered fireproofed hoses without damaging the fire-proofing or interlocking armor shield. Thus, the existing safety clamps are not able to achieve necessary safety conditions for the workers under extreme conditions of greater than 5,000 psi pressure.

A rotary or vibrator hose becomes a choke and kill (Choke and Kill or C&K) hose when fireproofing and stainless steel armor are added to the outside of the hose. This fireproofing and stainless steel armor disqualifies the use of conventional safety clamps from practical application because the conventional safety clamp cannot be “snugly fit” to the outside surface of the hose without damaging the armor and fireproofing.

Existing safety clamps hold the hose in a manner such that the exterior components of the hose, the fire-proofing material and/or armor on the exterior of the hose, is damaged by the tightening of the clamp, thereby causing failure, which could result in explosion, fire or leakage. Moreover, the conventional safety clamps do not have any feature to hold the fireproofed Choke and Kill hose intact in case of such accidents. For instance, at oil field derrick sites, when a hose connection failure occurs, the hose may get released from the safety clamp and fall on or hit workmen at the site. Additionally, the conventional safety clamps are not often strong enough to hold Choke and Kill hoses that carry fluids or media under high pressure conditions. Over time, the diameters, lengths and working pressure of the hoses have been increasing to meet the high operating pressure demands. The conventional safety clamps with two total bolts (one on each side of the flange) tend to fail as single bolts do not cope well with the constant high pressure and vibration conditions the hose is exposed to. Failure of conventional clamps often occurs when one bolt on the clamp fails, causing the entire clamp to fail to secure the hose. Thus, there is a continued need in the industry for modifications to the safety clamp to handle current working pressure and larger sizes of hoses. In particular, there continues to exist a need for safety clamps to be used with vibrator, rotary, and most preferably Choke and Kill hoses.

Prior art was not located for safety clamps specifically designed for Choke and Kill hoses, or hoses in general having external rubber elements, and internal metal components. A safety clamp is needed for these type of hoses that can secure onto the hose yet not damage the internal components. Art was located for safety clamps to be used as repair clamps for pipes or non-rubber based hoses. These conventional repair clamps are not suitable for Choke and Kill hoses since they tend to damage the internal components as they squeeze or secure onto the hose.

U.S. Pat. No. 4,653,782 discloses a pipe repair clamp with a two piece split collar having four bolt openings. The two split collar is placed around the surface of a pipe to be repaired. However, the pipe repair clamps cannot be used during operation at construction sites and oil drilling sites to hold hoses that carry fluids under high pressure since the pipe repair clamps are only used to repair pipes during leakage. Moreover, the pipe repair clamp cannot hold a Choke and Kill Hose during pressures as used in oil field applications nor without damaging the fire-proofing armor of the Choke and Kill hoses.

U.S. Pat. No. 5,090,742 discloses a pipe harness clamp with six bolt openings. The pipe harness clamp is used to couple two pipes of same or different material. However, the pipe harness clamp does not include a means to attach the clamp to a secure immovable structure to hold a pipe under extreme pressure in the event of a well blowout as required for a Choke and Kill hose.

For exemplary purposes, the repair clamps are shown in FIGS. 4-6. While they contain hose covers, flanges, and bolts, they are not constructed in accordance with standard practices for use under high pressure conditions for holding Choke and Kill hoses which are fire-proofed and armored, nor with safety chains which attach safety clamps and Choke and Kill hoses to immovable objects. In an oil field application, a major objective of the safety clamp is to secure the high pressure hose to an immovable object and avoid accidental harm to humans should there be a hose failure. The clamp, clamp bolts and the hole to secure the chain or wire rope sling, must be sufficient to hold the hose during use, and to prevent the hose flying around loose and causing harm in the event of hose failure.

In light of the foregoing, there continues to exist a need for an Integrated Safety Clamp (which in particular meets API 7K specifications) that handles Choke and Kill hoses defined as (Rotary Vibrator hoses with neoprene fire-proofing and stainless steel armor outer wrap) carrying fluids under high pressure and securely restrains a Choke and Kill hose in the event of a hose failure without compromising the stainless steel armor which covers the fire-proofing material (neoprene) on the outside of the hose during an accidental failure. This is the integration link between the hose and fire-proofing/armor.

### SUMMARY

Disclosed herein is an Integrated Safety Clamp for use on vibrator, rotary, and in particular Choke and Kill hoses. While more so designed to fit snugly around the Choke and Kill hose without damaging the fire-proofing armor, the inventive clamp is useful for vibrator and rotary hoses as well. The inventive clamp shall be described relative to use on a Choke and Kill hose, but those of skill in the art will recognize its' utility on other types of hoses exposed to high pressure, and extreme work conditions such as on an oil derrick. The inventive clamp is comprised of a pair of identical main bodies with the same outside diameter but with two differing internal diameters. The middle five inches of the main body has a wall thickness varying from about 0.3125 ( 5/16) inch to 0.75 (¾) inch, depending on the size of the hose, allowing it to fit over the fire-proofing and the hose. The two 2.5 inch eaves or outer ends of the main body have a thinner wall thickness of about 0.125 (⅛) inch allowing the clamp to fit over the hose, fire-proofing material, and armor. Each main body member is coupled to form the complete clamp. On the centered outer edge of each main body, a set of five inch flanges having two bolt openings on each flange (four minimum per clamp assembly) are attached. An opening for a safety chain or wire rope sling is on one of these flanges which is longer allowing for the safety chain or rope to be attached thereto. The clamp comprises
a) a main body with miter cut connecting edges to ease coupling and insure correct alignment of each main body member at the time of fabrication and installation;
b) gussets for strengthening between the flanges and main body;
c) protruding bolts from each flange with at least two holes on each side thereof for securing the flanges together and preventing clamp failure;
d) an additional hole for placement of a safety chain or wire rope sling; and
e) internal diameters of two different sizes to allow the clamp to fit over the fire-proofed hose and its external armor,
   wherein further the clamp will not damage the external media of the hose or reduce the internal or external diameter of the hose while the hose is in use under high pressure. For purposes herein, high pressure is defined to mean at least or greater than 5,000 psi pressure at any given working moment.

An object of the present invention is therefore to provide an Integrated Safety Clamp that is mounted on a hose carrying media under high pressure. Integrated herein means a clamp having two halves used ultimately as one unit together with the hose and will not damage, compromise or interfere with the armor or internal components of the hose. Media can be fluids or associated materials going through a hose dedicated to work under high pressure conditions. The Integrated Safety Clamp will not damage or interfere with the external media or workings of the hose while in use, or out of use, nor will it alter the internal or external diameter of the hose once the clamp is secured on the hose. The inventive clamp has at least two additional holes for securing the clamp to the hose and differing interior dimensions that allow for a snug fit over the fire-proofing and armor without causing damage than that currently in the art. While it may seem an obvious change to make compared to stand safety clamps, it is not believed obvious since the likelihood of both connection bolts on one side of the present invention breaking at the same time is unlikely. The current conventional safety clamps with two bolts, one on each flange, will fail if one of the two total bolts breaks under high pressure thus causing the entire clamp useless and allowing a safety hazard. Whereas with a four bolt Integrated Safety Clamp, if one bolt breaks, the user still has three additional bolts holding the clamp onto the hose thus remaining a functional safety clamp. In addition, the current conventional safety clamp will not snugly fit over the fire-proofing and armor required for high pressure materials without damaging it, and the inventive clamp will fit over the hose and its protective external materials without damaging them due to its two different internal diameters.

The four 0.75 (¾) inch connection bolts used with the present Integrated Safety Clamp are also larger than currently available in order to maintain clamping placement on Choke and Kill hoses and to minimize possible loss of snug fit installation due to a broken or damaged connection bolt than a current two 0.50 (½) inch bolt configuration safety clamp would have. This not only sustains functionality, but provides more safety with this clamp during use. The inventive clamp is a stronger clamp utilizing not only larger bolts but also a safety chain or wire rope sling, a larger main body and flanges with gussets which together minimize or allow for no weak points in the clamp unit. The gussets of the current embodiment are 0.375 (⅜) inch material, cut to fit the exact curvature of each clamp size.

In an embodiment, the inventive safety clamp with two differing internal diameters has a first main body that includes a first and a second longitudinal end, and a second main body that includes a third and a fourth longitudinal end. The safety clamp includes first and second pairs of flanges attached to the first and second main bodies. The first and second pairs of flanges are attached to the first through fourth longitudinal ends of the first and second main bodies, respectively. Each flange of the first and second pairs of flanges includes two bolt openings. The Integrated Safety Clamp includes at least four bolts to securely connect the bolt openings thereby forming an enclosure to hold the hose carrying high pressure media such as oil and chemicals. The Integrated Safety Clamp further includes first through fourth pairs of gussets that provide mechanical support to attachments of the first and second pairs of flanges. The inventive safety clamp further includes an attachment opening on the longer flange of the first main body to secure a chain or wire rope sling to connect to an immovable object for safety. Traditionally, the immovable object during use of the hose is an oil derrick but can be other objects that may be available.

### BRIEF DESCRIPTION OF DRAWINGS

The features of the present invention, which are believed to be novel, are set forth with particularity in the appended claims. Embodiments of the present invention will hereinafter be described in conjunction with the appended drawings provided to illustrate and not to limit the scope of the claims, wherein like designations denote like elements, and in which:

FIGS. 1A and 1B show a perspective view of the clamp having both halves;

FIG. 2 shows a top view of the Clamp and the two internal diameters;

FIG. 3 shows a perspective view of a first main body with flanges; and,

FIGS. 4, 5, and 6 show representative comparative repair clamps for pipes.

### DETAILED DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components which constitutes a safety clamp that securely holds a hose having four bolt openings. Accordingly, the components and the method steps have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

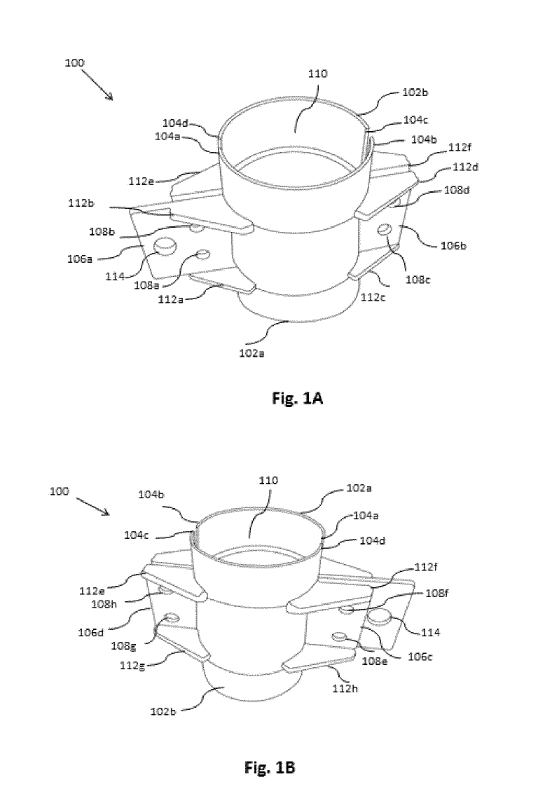

A safety clamp 100 that includes a first main body 102a and a second main body 102b is shown in FIGS. 1A and 1B. The first main body 102a includes a first longitudinal end 104a and a second longitudinal end 104b. The second main body 102b includes a third longitudinal end 104c and a fourth longitudinal end 104d. The first main body 102a and the second main body 102b are semicircular in shape and designed to securely and accurately match with the other half or other main body. In an embodiment, the first and second main bodies 102a and 102b are made of steel.

Materials for the clamp are preferably those of robust metals such as steel, cast steel, and aluminum. Due to the nature of the job required of the clamp during high pressure, brittle metals or those with a tendency to corrode are generally unacceptable. Unacceptable metals include iron because with it will not withstand the violent conditions (eg. whipping action) and corrosive conditions (eg. acidic, or caustic fluids) that occur upon hose failure.

The first main body 102a has first and second flanges 106a and 106b (collectively referred to as a “first pair of flanges”) attached to the first longitudinal end 104a and the second longitudinal end 104b, respectively. Further, the second main body 102b has third and fourth flanges 106c and 106d (collectively referred to as a “second pair of flanges”) attached to the third longitudinal end 104c and the fourth longitudinal end 104d, respectively. The first through fourth flanges 106a-106d are attached to the first through fourth longitudinal ends 104a-104d, respectively. In an embodiment, the first through fourth flanges 106a-106d are welded to the first through fourth longitudinal ends 104a-104d of the first main body 102a and the second main body 102b, respectively. In another embodiment, the first and second flanges 106a-106b and the first main body 102a may be a single forged assembly. In yet another embodiment, the first through fourth flanges 106a-106d are made of steel. In yet another embodiment, the thickness of each of the first through fourth flanges 106a-106d is 0.375 (⅜) inch.

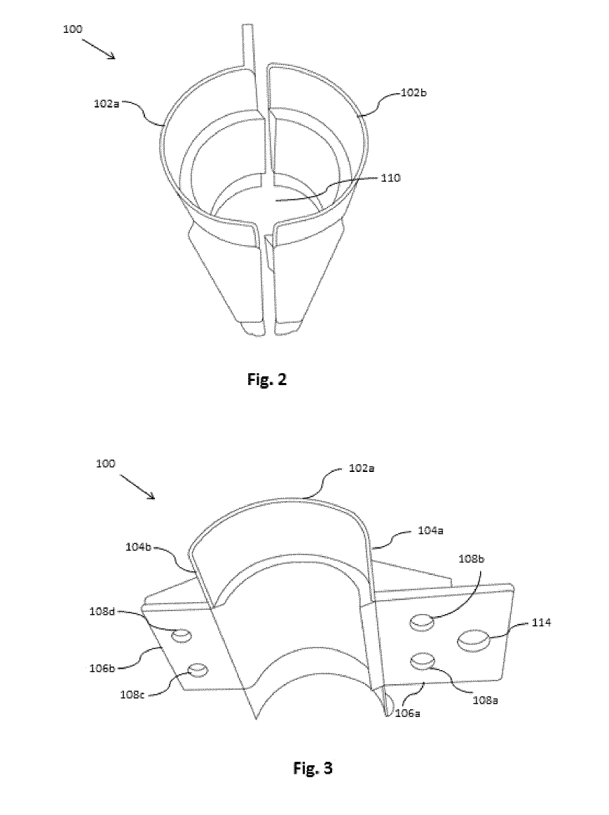

The first through fourth flanges 106a-106d have first through eighth bolt openings 108a-108h (hereinafter, collectively referred to as “bolt openings 108”). Each flange has two bolt openings. The bolt openings 108 are circular in shape to accommodate conventional bolts. In an embodiment of the present invention, the position and size of the bolt openings 108 are 0.8125 ( 13/16) inch diameter and positioned two inches apart center to center. FIG. 2 shows a top view of the safety clamp 100. The enclosure 110 is formed when the first main body 102a and second main body 102b are coupled together. The bolt openings 108 allow multiple bolts (not shown) to couple the first main body 102a and the second main body 102b, thereby forming the enclosure 110. The enclosure 110 holds a hose therein. In an embodiment of the present invention, each of the bolt openings 108 holds a bolt of 0.75 (¾) inch diameter. In another embodiment, an internal diameter of the enclosure 110 ranges between about 3.30-6.5 inches for the Choke and Kill hose. It is well understood to a person skilled in the art that the size of the bolts and the diameter of the enclosure 110 are not restricted to the aforementioned values provided they are of sufficient size and suitable material to withstand potential whipping action should hose failure occur upon use of the hose under high pressure work site conditions.

The eves on the outer edge of the present safety clamp are for the purpose of covering the fireproof material and stainless steel armor that is wrapped on the outside of the hose and protecting it from fire damage. The inventive clamp allows for the fireproofing material to not be disturbed or compromised during use of the hose, in particular during the installation and tightening of the clamp onto the hose. Conventional safety clamps do not withstand the rugged conditions needed of a safety clamp used under high pressure, nor do conventional safety clamps protect the fireproofing armor found on a Choke and Kill hose. Generally conventional clamps do not fit snuggly over a fireproofed hose without damaging the fireproofing materials or armor. If the armor is pinched or bent during the installation of the clamp, it is damaged, compromised and weakened during use under high pressure being a potential safety hazard for the workers.

The first through eighth gussets 112a-112h (collectively referred to as “first through fourth pairs of gussets” or “gussets”) supports attachments between the first through fourth flanges 106a-106d and the first and second main bodies 102a and 102b, respectively. The gussets 112a-112h are brackets used to strengthen an angle connecting the flanges 106a-106d to the first main bodies 102a and 102b. The shape of each of the brackets is chosen accordingly to the shape of the main bodies 102a and 102b. The gussets 112a-112h protect the four flanges 106a-106d from breaking and hence secure the enclosed hose. In an embodiment of the present invention, the thickness of each gusset 112a-112h is 0.375 (⅜) inch however the thickness can range from about ¼ inch to about ⅝ inch. In another embodiment of the present invention, the gussets 112a-112h are welded to the four flanges 106a-106d and to the first and second main bodies 102a and 102b.

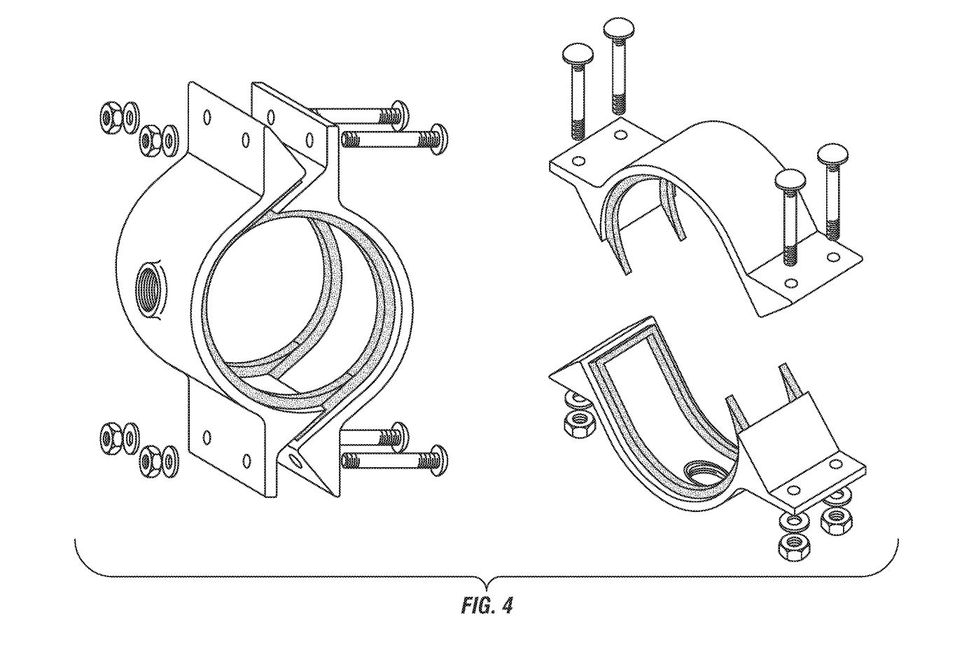

FIG. 3 illustrates the first main body 102a of the safety clamp 100 with the first and second flanges 106a and 106b. The first flange 106a has a protruding portion that includes an attachment opening 114. The attachment opening 114 is used to secure a chain or wire rope cable (sling) to the safety clamp 100. One end of the chain or wire cable is connected to the safety clamp 100 and the other end of the chain or wire cable is connected to a secure object to withstand the weight and the force of the hose. These embodiments generally find application in the oil and gas field where hoses such as the Choke and Kill Hoses are used. For safety purposes, the attachment opening 114 with the secured chain or wire rope sling allows the safety clamp 100 to maintain restraint of a hose in the event of a hose failure. In an embodiment of the present invention, a diameter of the attachment opening 114 is 1.125 (1⅛) inches. The diameter of the chain or rope attachment opening is dependent upon the rope to go through the opening. The opening can range from about 1.125 (1⅛) inch to about 1.188 (1 3/16) inches. Conventional safety chains or wire cable are about 0.5 (½) inch to 0.75 (¾) inch diameter respectively, and therefore the opening on the clamp needs to fit the securing chain.

In an embodiment of the present invention, the first main body 102a and the second main body 102b is a combination of three semicircular tubing materials attached together, a five inch mechanical tubing center with varying wall thicknesses of 0.3125 ( 5/16) inch-0.75 (¾) inch, that serves as the contacting clamp body to hose surface section, and the outer ends (eaves) manufactured from 0.125 (⅛) inch by 2.5 inch long tubing which fit over the armor. The proper size tubing material in relationship to the proper hose size assures a snug fit to the hose, fire-proofing, and armor without damaging it. It is important that the clamp fit snug and not damage or compromise the fireproofing shield and armor associated with the hose. This distinguishes a Choke and Kill hose from a traditional vibrator or rotary hose which are missing such fireproofing materials.

The safety clamp 100 with four bolts (unlike standard two bolts) ensures that a hose is securely held even when one of the bolts fails, breaks or loosens. The safety clamp 100 is robust in structure and firmly holds the Choke and Kill hose which carries fluids under high pressure and are wrapped with a fireproof material. The safety clamp 100 is used to hold the hoses wrapped with the fireproof shield. The hose is marked with a notation “Attach Safety Clamp Here” at a predefined point. The safety clamp 100 is mounted on the fireproof shielded hose at the predefined point on the hose. The clamp location is guided by principles set forth by the American Petroleum Institute (API).

The safety clamp 100 can restrain hoses with pressure of 5,000 psi and more. Thus, the safety clamp 100 is strong enough to hold a Choke and Kill hose carrying a broad range of chemicals or fluids at relatively high pressure. The safety clamp 100 can withstand the force of hose failure reaction and firmly hold the hose at its initial position.

The safety clamp 100 is designed and manufactured for the specific hose size so when it is installed around the hose, over tightening cannot occur thus altering the shape, the diameter, or the internal media of the hose. The safety clamp 100 is a proactive measure to serve as a functioning safety clamp, complying to API 7L A.7 specifications while enabling complete fire proofing coverage of Choke and Kill hoses.

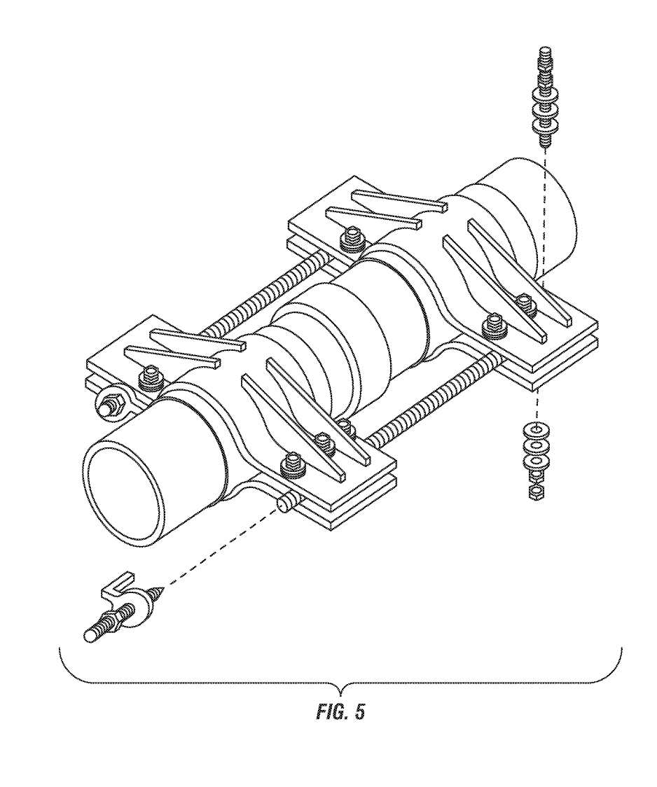

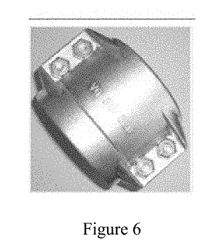

FIGS. 4-6 show representative repair clamps for comparison to the present safety clamp. Missing is the attachment hole for a chain, the two internal diameters so as to fit snug over a Choke and Kill hose, and the ability to not over tighten and damage any fireproofing shield and armor on the hose. A repair clamp is not a safety clamp since the intent is to temporarily fix or repair steel or rigid wall pipe. In light of Choke and Kill hoses, the repair clamp would not be suitable for rubber hoses.

The present invention has been described herein with reference to a particular embodiment for a particular application. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claim.

What is claimed is:

1. A safety clamp for use with hoses having fireproof shielding and armor comprising a pair of identical main bodies with attached flanges, coupled to each other the improvement comprising:
a) said flanges having at least two bolt openings on each flange end, with one flange being longer to allow an opening for a safety attachment;
b) the main body having miter cuts connecting the edges for ease in coupling and to insure correct alignment of each main body member at the time of fabrication;
c) the clamp having gussets between the flanges and main body;
d) an additional hole on the longer flange; and
e) the clamp having internal diameters of two different sizes allowing the clamp to fit over the fire-proofed hose and its external armor.

2. The clamp of claim 1 made from steel.

3. A safety clamp for use with hoses having fireproof shielding and external armor comprising:
a) a pair of identical main bodies having main body miter cut connecting edges for ease in coupling a with attached flanges having gussets, said flanges coupled to each other having at least two total bolt openings on each flange end, with one flange being longer to allow an opening for a safety attachment;
b) the main bodies have the same external diameter but two differing internal diameters;
c) protruding bolts from each flange with two holes on each side thereof for securing the flanges together and preventing clamp failure;
d) having an additional hole for placement of a safety chain or wire rope sling; and
e) internal diameters of two different sizes allowing the clamp to fit over the fire-proofed hose and its external armor;
wherein further the clamp will not damage the internal media of the hose, or reduce the internal or external diameter of the hose while the hose is in use under high pressure.

4. The safety clamp of claim 1, wherein the high pressure media includes at least one of oil, gas, and chemical.

5. The safety clamp of claim 1, wherein the hose is at least one of a choke and kill hose, a rotary hose, and a vibratory hose.

6. The safety clamp of claim 3, wherein the first and second main bodies are made of at least one of iron and steel.
